(19) United States
(12) Patent Application Publication
(10) Pub. No.: US 2025/0239409 A1
(43) Pub. Date: Jul. 24, 2025

(54) ELECTRONIC COMPONENT, MOUNTING STRUCTURE FOR ELECTRONIC COMPONENT, AND SEPARATION METHOD FOR ELECTRONIC COMPONENT

(71) Applicant: Murata Manufacturing Co., Ltd., Nagaokakyo-shi (JP)

(72) Inventors: Keijiro KOJIMA, Nagaokakyo-shi (JP); Takumi MASAKI, Nagaokakyo-shi (JP)

(73) Assignee: Murata Manufacturing Co., Ltd., Nagaokakyo-shi (JP)

(21) Appl. No.: 19/172,816

(22) Filed: Apr. 8, 2025

Related U.S. Application Data
(63) Continuation of application No. PCT/JP2023/023793, filed on Jun. 27, 2023.

(30) Foreign Application Priority Data
Dec. 22, 2022 (JP) 2022-205383

(51) Int. Cl. H01G 4/30; H01G 4/008; H01G 4/232

(52) U.S. Cl. CPC H01G 4/30; H01G 4/008; H01G 4/232

(57) ABSTRACT

An electronic component including an element body including a dielectric layer and having a top surface and a bottom surface facing each other in a height direction, a first side surface and a second side surface facing each other in a length direction orthogonal to the height direction, and a third side surface and a fourth side surface facing each other in a width direction orthogonal to the height direction and the length direction, an external electrode provided on a surface of the element body, and a microwave absorbing layer located on at least one of the top surface, the first side surface, the second side surface, the third side surface, or the fourth side surface and provided so as to be in contact with the external electrodes.

### CROSS-REFERENCE TO RELATED APPLICATIONS

The present application is a continuation application of PCT International Application No. PCT/JP2023/023793 filed on Jun. 27, 2023, designating the United States of America, which is based on and claims priority to Japanese patent application JP 2022-205383, filed Dec. 22, 2022. The entire disclosures of the above-identified applications, including the specifications, the drawings, and the claims are incorporated herein by reference in their entirety.

### BACKGROUND

In recent years, a circular economy, where components are reused, has been socially demanded. However, mounted electronic components are often crushed and discarded. In order to circulate or reuse these resources, it is necessary to perform a pretreatment for separating and selecting each component and increasing a predetermined metal concentration. As a separation technique, mechanical peeling, whole heating, and the like are known.

A technique for mounting an electronic component on a substrate includes selectively heating a heat generation pattern on a support body by irradiation of the support body with a microwave so that solder on the substrate arranged on the support body is heated in accordance with the heat generation pattern, and bonding an electrode of an electronic component to an electrode pattern on the substrate via the solder.

A method of measuring a temperature characteristic of a material constant using a cavity resonator method is known.

### SUMMARY

According to a first aspect of the present disclosure, there is provided an electronic component including an element body including a dielectric layer and having a top surface and a bottom surface facing each other in a height direction, a first side surface and a second side surface facing each other in a length direction orthogonal to the height direction, and a third side surface and a fourth side surface facing each other in a width direction orthogonal to the height direction and the length direction, an external electrode provided on a surface of the element body, and a microwave absorbing layer located on at least one of the top, the first side surface, the second side surface, the third side surface, or the fourth side surface and provided so as to be in contact with the external electrode.

According to a second aspect of the present disclosure, there is provided an electronic component including an element body including a dielectric layer and having a top surface and a bottom surface facing each other in a height direction, a first side surface and a second side surface facing each other in a length direction orthogonal to the height direction, and a third side surface and a fourth side surface facing each other in a width direction orthogonal to the height direction and the length direction, an external electrode provided on a surface of the element body, and a microwave absorbing layer located on at least one of the top, the first side surface, the second side surface, the third side surface, or the fourth side surface and provided so as to be isolated from the external electrode. A dielectric loss factor that is the product of a dielectric constant and a dielectric loss tangent of the microwave absorbing layer is two times or more a dielectric loss factor that is the product of a dielectric constant and a dielectric loss tangent of the dielectric layer.

According to a third aspect of the present disclosure, there is provided a separation method for an electronic component, the separation method including preparing the mou electronic component, irradiating a microwave absorbing layer of the electronic component with a microwave to heat the microwave absorbing layer, and melting solder to separate the electronic component from a mounting substrate.

### BRIEF EXPLANATION OF DRAWINGS

FIG. 1 is a perspective view schematically illustrating an example of an electronic component according to an exemplary embodiment of the present disclosure.

FIG. 2 is an example of a sectional view taken along line A-A of the electronic component illustrated in FIG. 1.

FIG. 3 is another example of the sectional view taken along line A-A of the electronic component illustrated in FIG. 1, and illustrates a case where the electronic component is a multilayer ceramic capacitor.

FIG. 4 is a sectional view schematically illustrating a first variation of an electronic component element body according to the exemplary embodiment of the present disclosure.

FIG. 5 is a sectional view schematically illustrating a second variation of the electronic component element body according to the exemplary embodiment of the present disclosure.

FIG. 6 is a sectional view schematically illustrating a third variation of the electronic component element body according to the exemplary embodiment of the present disclosure.

FIG. 7 is a perspective view schematically illustrating a fourth variation of the electronic component element body according to the exemplary embodiment of the present disclosure.

FIG. 8 is a perspective view schematically illustrating an example of a mounting structure for an electronic component according to an exemplary embodiment of the present disclosure.

FIG. 9 is a sectional view schematically illustrating an example of an aspect in which an electronic component is irradiated with a microwave in a separation method for an electronic component according to an exemplary embodiment of the present disclosure.

FIG. 10 is a sectional view schematically illustrating an example of an aspect in which an electronic component is separated in the separation method for an electronic component according to an exemplary embodiment of the present disclosure.

### DETAILED DESCRIPTION

In a case where the technique described above is to be used for separation of a mounted electronic component, a heat generation pattern that absorbs a microwave and generates heat is provided on a support body. For this reason, an electronic component to be separated cannot be arbitrarily selected.

Further, the technique can be applied only to an electronic component mounted on a corresponding substrate.

Furthermore, since a metal portion is heated by an electromagnetic wave in the technique described above, in a separation stage of a mounted electronic component, that is, in a discarding stage of the product, heating efficiency may be extremely lowered due to adhesion of flux and a foreign matter to a metal portion.

The present disclosure has been made to solve the above situation, and an aspect of the present disclosure is to provide an electronic component that can be easily separated from a substrate, a mounting structure for an electronic component, and a separation method for an electronic component.

According to the present disclosure, it is possible to provide an electronic component that can be easily separated from a substrate, a mounting structure for an electronic component, and a separation method for an electronic component.

Hereinafter, an electronic component, a mounting structure for an electronic component, and a separation method for an electronic component according to the present disclosure will be described.

However, the present disclosure is not limited to a configuration below, and can be appropriately modified and applied within a range in which the gist of the present disclosure is not changed. Note that the present disclosure also includes a combination of two or more of individual desirable configurations described below.

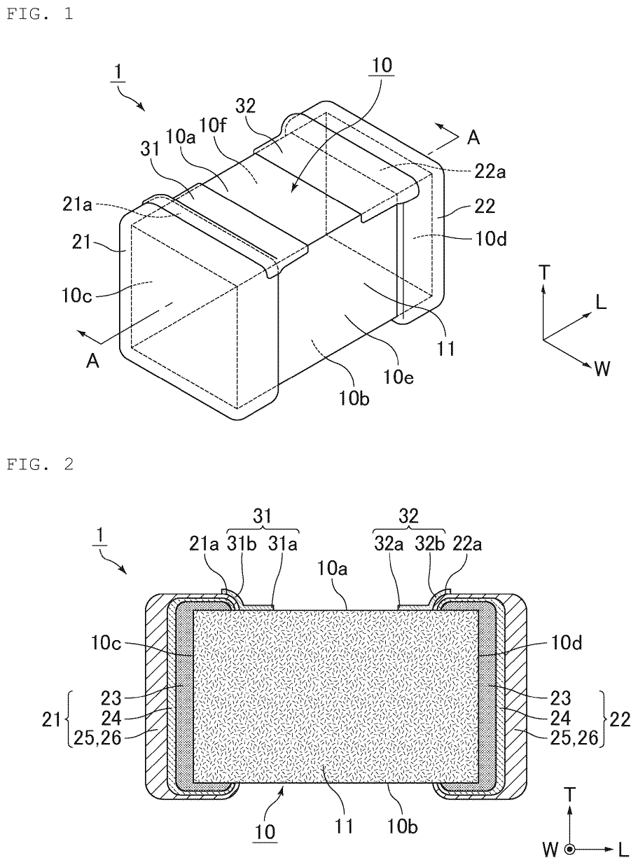

First, the electronic component according to an exemplary embodiment of the present disclosure will be described. FIG. 1 is a perspective view schematically illustrating an example of the electronic component according to the exemplary embodiment of the present disclosure.

An electronic component 1 illustrated in FIG. 1 is a chip type electronic component (surface mount electronic component), and includes an element body 10, external electrodes 21 and 22, and microwave absorbing layers 31 and 32.

A specific type of the electronic component 1 is not particularly limited as long as it is a component that can be mounted on a mounting substrate by solder.

Specifically, multilayer ceramic electronic components such as a multilayer ceramic capacitor, a multilayer coil, a multilayer thermistor, a multilayer varistor, a multilayer LC filter, and a multilayer piezoelectric filter are used.

In this case, the element body 10 preferably includes a multilayer body in which at least any of a dielectric ceramic layer, a magnetic ceramic layer, a piezoelectric ceramic layer, and a semiconductor ceramic layer and an internal electrode layer as an internal conductor are layered.

Further, the electronic component 1 does not need to be a multilayer component as described above, and specific examples in this case include a silicon capacitor, a ferrite coil, and an inductor including a composite material of metal powder and resin.

The element body 10 includes a dielectric layer 11 and an internal conductor (internal electrode layer, not illustrated in FIG. 1), and has a top surface 10a and a bottom surface 10b facing each other in a height direction T, a first side surface 10c and a second side surface 10d facing each other in a length direction L orthogonal to the height direction T, and a third side surface 10e and a fourth side surface 10f facing each other in a width direction W orthogonal to the height direction T and the length direction L.

As described above, the element body 10 has a substantially rectangular parallelepiped outer shape, but may have a corner portion and a ridge portion that are rounded. The corner portion is a portion where three surfaces of the element body 10 intersect, and the ridge portion is a portion where two surfaces of the element body 10 intersect.

Note that areas of the top surface 10a and the bottom surface 10b may be substantially the same as or different from areas of the third side surface 10e and the fourth side surface 10f. Further, areas of the first side surface 10c and the second side surface 10d may be substantially the same as or different from areas of the third side surface 10e and the fourth side surface 10f.

A surface of the element body 10 is constituted by the dielectric layer 11 except for an exposed portion of an internal conductor.

The dielectric layer 11 can be formed of, for example, a dielectric material (oxide). The dielectric material can be appropriately selected according to a type of the electronic component 1, and examples of the dielectric material include a dielectric ceramic material, a magnetic ceramic material, a piezoelectric ceramic material, and a semiconductor ceramic material.

Among them, as the dielectric material, a dielectric ceramic material containing a main component such as barium titanate, calcium titanate, strontium titanate, barium calcium titanate, or calcium zirconate is suitable. Such a material has a low dielectric loss factor at any point in a temperature range from room temperature to a melting point of solder, and temperature rise due to microwave irradiation hardly occurs, so that an effect by the microwave absorbing layers 31 and 32 described later is easily obtained. In a case where the dielectric ceramic material described above is contained as a main component, the electronic component 1 may function as a multilayer ceramic capacitor. However, depending on a characteristic of a desired multilayer ceramic capacitor, an electronic component to which an accessory component having a content smaller than that of a main component, such as a Mg compound, a Mn compound, a Si compound, an Al compound, a V compound, a Ni compound, or a rare earth compound, is added may be used.

As the dielectric material, a magnetic ceramic material containing a main component such as a ferrite ceramic material is also suitable. Such a material takes time to absorb a microwave, and thus, also in this case, an effect of the microwave absorbing layers 31 and 32 described later is easily obtained. In a case where a magnetic ceramic material is used, the electronic component 1 may function as a multilayer coil.

For example, as a specific example of the piezoelectric ceramic material, a lead zirconate titanate (PZT)-based ceramic material or the like is used. In a case where the piezoelectric ceramic material is used, the electronic component 1 may function as a multilayer piezoelectric filter.

For example, as a specific example of the semiconductor ceramic material, a spinel-based ceramic material is used. In a case where the semiconductor ceramic material is used, the electronic component 1 may function as a multilayer thermistor.

The external electrodes 21 and 22 are provided on a surface of the element body 10.

The external electrode 21 is provided on the first side surface 10c of the element body 10. In FIG. 1, the external electrode 21 is provided from the first side surface 10c of the element body 10 to each of the top surface 10a, the bottom surface 10b, the third side surface 10e, and the fourth side surface 10f. The external electrode 21 is electrically connected to an internal conductor exposed from the element body 10 on the first side surface 10c.

The external electrode 22 is provided on the second side surface 10d of the element body 10. In FIG. 1, the external electrode 22 is provided from the second side surface 10d of the element body 10 to each of the top surface 10a, the bottom surface 10b, the third side surface 10e, and the fourth side surface 10f. The external electrode 22 is electrically connected to an internal conductor exposed from the element body 10 on the second side surface 10d.

FIG. 2 is an example of a sectional view taken along line A-A of the electronic component illustrated in FIG. 1. Note that, in FIG. 2 and FIGS. 4 to 6, 8, and 9 to be described later, illustration of an internal conductor of the element body 10 is omitted.

As illustrated in FIG. 2, the external electrodes 21 and 22 have a resin electrode layer 23 containing a conductive component and a resin component. The conductive component contains, as a main component, single metal such as silver, copper, nickel, or tin, or an alloy containing at least one of these types of metal. The resin component contains epoxy resin, phenol resin, or the like as a main component. The resin electrode layer can be formed using, for example, conductive paste such as silver paste.

Note that the external electrodes 21 and 22 may include a baked electrode layer of copper or silver instead of the resin electrode layer 23. The baked electrode layer of copper or silver is specifically an electrode formed by baking a paste material of copper or silver containing a glass component.

Further, the external electrodes 21 and 22 have what is called a plating layer that is formed on the resin electrode layer 23 (may alternatively be a baked electrode layer of copper or silver, and this applies similarly hereinafter) by a plating method. Specifically, a Ni plating layer 24 provided so as to cover the resin electrode layer 23, and a Sn plating layer 26 as an outermost layer 25 provided so as to cover the Ni plating layer 24 are included.

Note that, as the outermost layer 25 of the external electrodes 21 and 22, an Au plating layer may be provided instead of the Sn plating layer 26.

Further, in the present disclosure, an external electrode only needs to be provided on a part of a surface of an element body, and an arrangement place of the external electrode is not particularly limited. For example, an external electrode may be arranged only on a bottom surface of an element body, may be arranged so as to cover a part of any side surface of an element body and to extend from the side surface to cover a part of a bottom surface (L-shape in sectional view), or may be arranged so as to cover a part or whole of any side surface of an element body and to extend from the side surface to cover a part of a top surface and a part of a bottom surface (C-shape in sectional view).

Further, in the present disclosure, the number of external electrodes is not particularly limited, and at least one external electrode only needs to be provided for an element body. For example, four external electrodes may be provided for an element body (four terminals), or six external electrodes may be provided for an element body (six terminals). In a case where a plurality of external electrodes are provided, it is preferable to provide at least one microwave absorbing layer for each external electrode so as to be in contact with the external electrode.

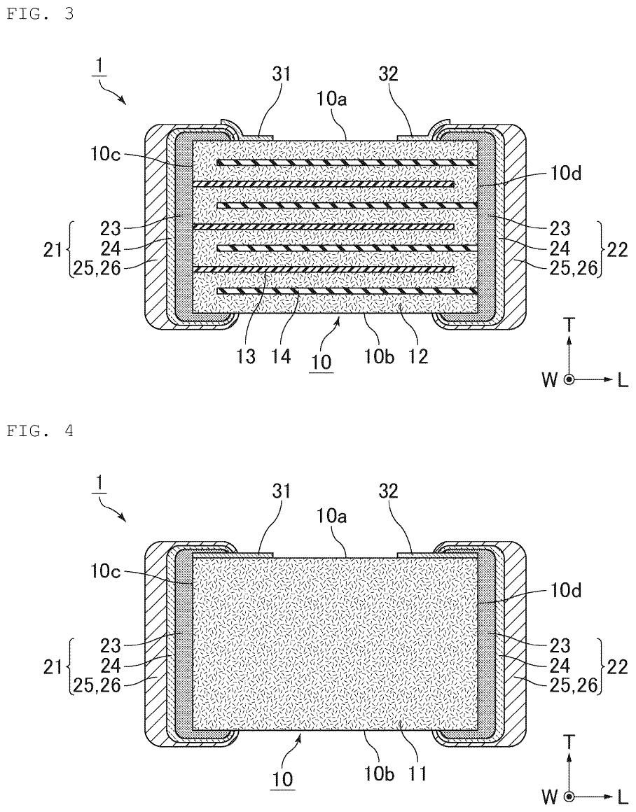

FIG. 3 is another example of the sectional view taken along line A-A of the electronic component illustrated in FIG. 1, and illustrates a case where the electronic component is a multilayer ceramic capacitor.

In this case, the element body 10 is a multilayer body in which a dielectric ceramic layer 12 as the dielectric layer 11 and internal electrode layers 13 and 14 as an internal conductor are layered.

The internal electrode layer 13 is drawn out to the first side surface 10c of the element body 10 and connected to the external electrode 21, and the internal electrode layer 14 is drawn out to the second side surface 10d of the element body 10 and connected to the external electrode 22.

The dielectric ceramic layer 12 can be obtained by sheet forming of dielectric slurry containing a dielectric ceramic material and an organic solvent.

The internal electrode layers 13 and 14 can be obtained by applying an electrode paste containing a conductive component. The internal electrode layers 13 and 14 are preferably Ni electrode layers using Ni as a conductive component.

Instead of a Ni electrode layer, an Ag electrode layer, a Pd electrode layer, or a Cu electrode layer may be used.

As illustrated in FIGS. 1 and 2, the microwave absorbing layer 31 is located on the top surface 10a of the element body 10 and is provided so as to be in contact with the external electrode 21. More specifically, the microwave absorbing layer 31 is provided at a position extending to the element body 10 and the external electrode 21 on the top surface 10a of the element body 10, and is selectively provided in a band shape in plan view on the top surface 10a of the element body 10 and the external electrode 21 so as to cover an end portion 21a located on the top surface 10a of the external electrode 21.

Similarly, the microwave absorbing layer 32 is located on the top surface 10a of the element body 10 and is provided so as to be in contact with the external electrode 22. Further, the microwave absorbing layer 32 is provided at a position extending to the element body 10 and the external electrode 22 on the top surface 10a of the element body 10, and is selectively provided in a band shape in plan view on the top surface 10a of the element body 10 and the external electrode 22 so as to cover an end portion 22a located on the top surface 10a of the external electrode 22.

Then, the microwave absorbing layer 31 has at least one of features (1) and (2) below.

(1) A dielectric loss factor P1, which is the product of a dielectric constant and a dielectric loss tangent of the microwave absorbing layer 31, is ten or more.

(2) The dielectric loss factor P1, which is the product of a dielectric constant and a dielectric loss tangent of the microwave absorbing layer 31, is two times or more a dielectric loss factor P, which is the product of a dielectric constant and a dielectric loss tangent of the dielectric layer 11 of the element body 10.

Similarly, the microwave absorbing layer 32 has at least one of features (3) and (4) below.

(3) A dielectric loss factor P2, which is the product of a dielectric constant and a dielectric loss tangent of the microwave absorbing layer 32, is ten or more.

(4) The dielectric loss factor P2, which is the product of a dielectric constant and a dielectric loss tangent of the microwave absorbing layer 32, is two times or more the dielectric loss factor P, which is the product of a dielectric constant and a dielectric loss tangent of the dielectric layer 11 of the element body 10.

Since the microwave absorbing layers 31 and 32 are provided so as to be in contact with the external electrodes 21 and 22, it is possible to selectively heat the microwave absorbing layers 31 and 32 by irradiating the electronic component 1 with a microwave (particularly, an electric field). Then, solder thermally conducted via the external electrodes 21 and 22 is melted, and the electronic component 1 can be easily separated from a mounting substrate. Therefore, it is possible to easily rebuild or recycle the electronic component 1.

Further, since the microwave absorbing layers 31 and 32 are provided on the electronic component 1, it is possible to target a specific electronic component and separate the specific electronic component from a mounting substrate (it is possible to selectively separate an electronic component having high resource value).

Further, since the microwave absorbing layers 31 and 32 are provided at positions extending over the element body 10 and the external electrodes 21 and 22, there is no scattering of flux at the time of microwave irradiation, contamination (adhesion of a foreign matter) is little after the electronic component 1 is used as a device, and lowering in heating efficiency due to microwave irradiation can be prevented.

Regarding the above (1) and (3), each of the dielectric loss factors P1 and P2, which are the product of a dielectric constant and a dielectric loss tangent of the microwave absorbing layers 31 and 32, is preferably ten or more, and more preferably 25 or more. If the dielectric loss factors P1 and P2 are less than ten, a heat generation rate by microwave absorption of the microwave absorbing layers 31 and 32 is low, and it may take time to dissolve solder. An upper limit of the dielectric loss factors P1 and P2 is not particularly limited, but is preferably 200 or less, and more preferably 100 or less. If the dielectric loss factors P1 and P2 exceed 200, a high-frequency characteristic of the electronic component 1 may be affected.

With regard to the above (2) and (4), the dielectric loss factors P1 and P2, which are the product of a dielectric constant and a dielectric loss tangent of the microwave absorbing layers 31 and 32, are each preferably two times or more, more preferably five times or more the dielectric loss factor P, which is the product of a dielectric constant and a dielectric loss tangent of the dielectric layer 11 of the element body 10. If a ratio of the dielectric loss factors P1 and P2 to the dielectric loss factor P is less than two times, a heat generation rate by microwave absorption of the microwave absorbing layers 31 and 32 is low, and it may take time to dissolve solder. An upper limit of a ratio of the dielectric loss factors P1 and P2 to the dielectric loss factor P is not particularly limited, but each of the dielectric loss factors P1 and P2 is preferably 40 times or less, more preferably 20 times or less the dielectric loss factor P. If a ratio of the dielectric loss factors P1 and P2 to the dielectric loss factor P exceeds 40, a high-frequency characteristic of the electronic component 1 may be affected.

Note that the dielectric loss factor P, which is the product of a dielectric constant and a dielectric loss tangent of the dielectric layer 11 of the element body 10, is preferably, for example, 0.1 or more and 5 or less.

In the present disclosure, in order to raise a temperature of solder to a melting point, a microwave absorbing layer needs to maintain a high dielectric loss factor in a temperature zone up to the melting point of the solder, and here, both a “dielectric constant” and a “dielectric loss tangent” of the microwave absorbing layer and a dielectric layer of an element body are values measured using a cavity resonator at 140° C. and in a 2.45 GHz band in accordance with a measurement method, for example, described in Akihisa Tsuchiya et al., “Method of Measuring Temperature Characteristics of Material Constant Using Cavity Resonator Method and Case of Measurement”, Measurement and Control, The Society of Instrument and Control Engineers, March 2014, Vol. 53, No. 3, pp. 192-196.

Note that a measurement temperature is set to 140° C. because, in a case of barium titanate, the Curie point of barium titanate is exceeded and a dielectric constant decreases, and, for this reason, a melting point of solder cannot be exceeded. Further, measurement becomes difficult at a high temperature, but there is a report example at 150° C. or less.

The microwave absorbing layers 31 and 32 can be formed of, for example, a non-oxide-based ceramic material such as aluminum nitride, silicon carbide, silicon nitride, or boron nitride. Since such a material has a large dielectric loss factor, temperature can be instantaneously raised by microwave irradiation.

Further, the microwave absorbing layers 31 and 32 can also be formed of an oxide-based ceramic material. Specifically, for example, since materials such as barium dititanate, barium titanate substituted by another element, alumina, zirconia, titanium oxide, and wollastonite have a large dielectric loss factor, temperature can be instantaneously raised by microwave irradiation. It is considered that since these materials have a high dielectric constant at 130° C. to 240° C. (the Curie point of barium titanate or more, and less than a melting point of solder), a dielectric loss factor is also high.

In addition, a composite material of these may also be a candidate for the microwave absorbing layers 31, 32.

Examples of a method for forming the microwave absorbing layers 31 and 32 include vapor deposition, sputtering, screen printing, spray coating, dispenser coating, and inkjet printing.

A thickness of the microwave absorbing layers 31 and 32 is preferably 0.1 μm or more and 10 μm or less, more preferably 0.5 μm or more and 5 μm or less, and still more preferably 1 μm or more and 3 μm or less. By the above, it is possible to prevent influence on a dimensional shape and a high frequency characteristic of the electronic component 1 while making the thickness sufficient for microwave absorption and heat conduction.

As illustrated in FIGS. 1 and 2, the microwave absorbing layer 31 is preferably provided so as to be in contact with the element body 10 and the external electrode 21. This allows instantaneous heating by microwave irradiation in a shorter period of time (using less energy).

Similarly, the microwave absorbing layer 32 is preferably provided so as to be in contact with the element body 10 and the external electrode 22.

Further, the microwave absorbing layer 31 is more preferably provided so as to be in contact with the element body 10 and the outermost layer 25 of the external electrode 21. This allows instantaneous heating by microwave irradiation in a further shorter period of time (using further less energy).

Similarly, the microwave absorbing layer 32 is more preferably provided so as to be in contact with the element body 10 and the outermost layer 25 of the external electrode 22.

FIG. 4 is a sectional view schematically illustrating a first variation of an electronic component element body according to the exemplary embodiment of the present disclosure. FIG. 4 corresponds to the sectional view of FIG. 2.

As illustrated in FIG. 4, the microwave absorbing layer 31 may be provided between the element body 10 and the external electrode 21 so as to be in contact with the element body 10 and the external electrode 21. In this case, a part of the microwave absorbing layer 31 is preferably exposed from the external electrode 21.

Similarly, the microwave absorbing layer 32 may be provided between the element body 10 and the external electrode 22 so as to be in contact with the element body 10 and the external electrode 22. In this case, a part of the microwave absorbing layer 32 is preferably exposed from the external electrode 22.

Further, as illustrated in FIG. 2, the microwave absorbing layer 31 is provided so as to be in contact with the element body 10 and the outermost layer 25 of the external electrode 22, and more preferably has at least one of an end portion 31a and a step portion 31b. When the end portion 31a and the step portion 31b are present, an electric field of a microwave is likely to concentrate. For this reason, instantaneous heating by microwave irradiation in a particularly short period of time is possible (energy used is particularly little).

Similarly, the microwave absorbing layer 32 is provided so as to be in contact with the element body 10 and the outermost layer 25 of the external electrode 22, and more preferably has at least one of an end portion 32a and a step portion 32b.

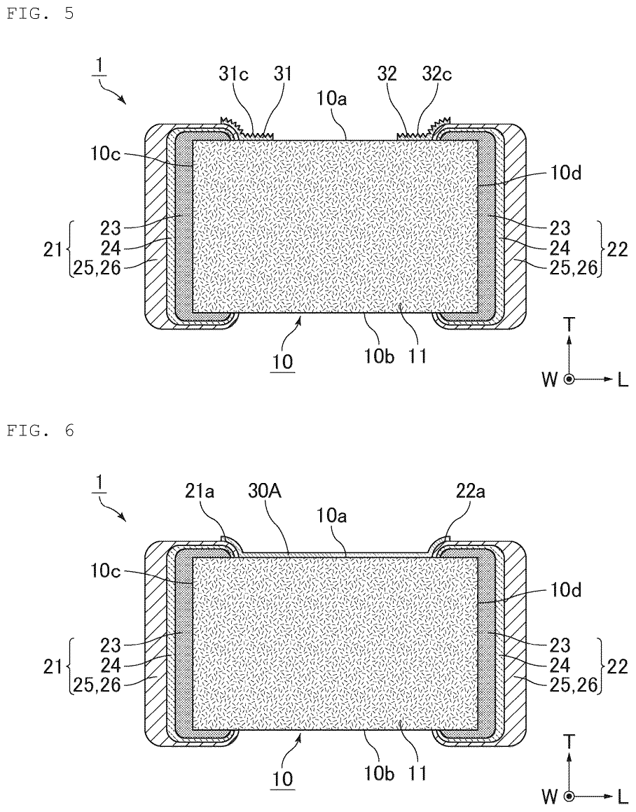

FIG. 5 is a sectional view schematically illustrating a second variation of an electronic component element body according to the exemplary embodiment of the present disclosure. FIG. 5 corresponds to the sectional view of FIG. 2.

As illustrated in FIG. 5, the microwave absorbing layer 31 is provided so as to be in contact with the element body 10 and the outermost layer 25 of the external electrode 22, and may have a pointed end portion 31c. Similarly in a case where the pointed end portion 31c is present, an electric field of a microwave is likely to concentrated. For this reason, instantaneous heating by microwave irradiation in a particularly short period of time is possible (energy used is particularly little).

Similarly, as illustrated in FIG. 5, the microwave absorbing layer 32 is provided so as to be in contact with the element body 10 and the outermost layer 25 of the external electrode 22, and may have a pointed end portion 32c.

Note that the pointed end portions 31c and 32c can be formed, for example, by making a surface of the microwave absorbing layers 31 and 32 a rough surface (uneven surface).

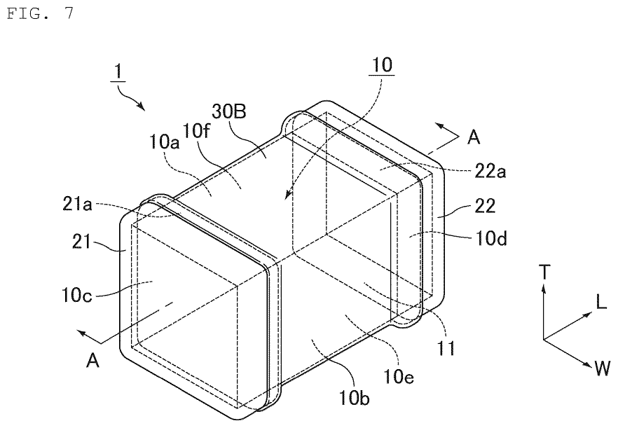

FIG. 6 is a sectional view schematically illustrating a third variation of the electronic component element body according to the exemplary embodiment of the present disclosure. FIG. 6 corresponds to the sectional view of FIG. 2.

As illustrated in FIG. 6, one microwave absorbing layer 30A may be provided so as to be in contact with both of the external electrodes 21 and 22. The microwave absorbing layer 30A is selectively provided in a rectangular shape in plan view on the top surface 10a of the element body 10 and the external electrodes 21 and 22 so as to cover the end portion 21a of the external electrode 21 and the end portion 22a of the external electrode 22 from the top surface 10a of the element body 10.

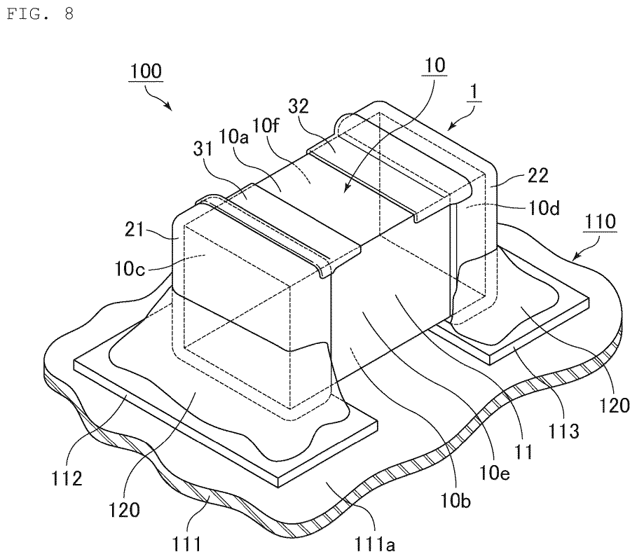

FIG. 7 is a perspective view schematically illustrating a fourth variation of the electronic component element body according to the exemplary embodiment of the present disclosure. FIG. 7 corresponds to the perspective view of FIG. 1.

As illustrated in FIG. 7, one microwave absorbing layer 30B may be provided so as to be in contact with both of the external electrodes 21 and 22. The microwave absorbing layer 30B surrounds the element body 10 all around between the external electrodes 21 and 22. More specifically, the microwave absorbing layer 30B is provided in an annular shape (belly band shape) on the top surface 10a, the bottom surface 10b, the third side surface 10e, and the fourth side surface 10f of the element body 10 not covered with the external electrodes 21 and 22 while overlapping the end portion 21a of the external electrode 21 and the end portion 22a of the external electrode 22.

Note that, in the present disclosure, the microwave absorbing layer only needs to be located on at least one of a top surface and four side surfaces of an element body, and an arrangement place of the microwave absorbing layer is not particularly limited. For example, the microwave absorbing layer may be provided so as to be in contact with an external electrode on a top surface of an element body and on any two opposing side surfaces (preferably, the third side surface 10e and the fourth side surface 10f) of the element body. Further, the microwave absorbing layer may be provided so as to be in contact with an external electrode only on any two opposing side surfaces (preferably, the third side surface 10e and the fourth side surface 10f) of an element body. Furthermore, as illustrated in FIG. 7, the microwave absorbing layer may be located on a bottom surface of an element body in addition to a top surface and at least one of four side surfaces of the element body.

Next, a mounting structure for an electronic component according to an exemplary embodiment of the present disclosure will be described. FIG. 8 is a perspective view schematically illustrating an example of the mounting structure for an electronic component according to the exemplary embodiment of the present disclosure.

A mounting structure 100 for an electronic component illustrated in FIG. 8 includes the electronic component 1 described above and a mounting substrate 110.

The mounting substrate 110 includes a substrate body 111 having a mounting surface 111a and land electrodes 112 and 113 formed on the mounting surface 111a. The substrate body 111 is formed of, for example, resin such as glass epoxy or ceramics such as glass ceramics. The substrate body 111 may be formed of a plurality of insulator layers that are layered. The mounting surface 111a is provided on one main surface of the substrate body 111. The land electrodes 112 and 113 are, for example, an electrode having a rectangular shape in plan view, and are arranged on the mounting surface 111a.

The external electrodes 21 and 22 of the electronic component 1 are electrically connected to the land electrodes 112 and 113 via solder 120, respectively. As described above, the land electrodes 112 and 113 are provided corresponding to the respective external electrodes 21 and 22, and the corresponding external electrode 21 or 22 and the land electrode 112 or 113 are connected and fixed to each other with the solder 120 interposed between them.

The solder 120 is made from an alloy containing Sn as a main component, and contains flux. The solder 120 is bonded to the outermost layer 25 of the external electrodes 21 and 22.

The electronic component 1 is mounted on the mounting substrate 110 such that the top surface 10a of the element body 10 faces the side opposite to the mounting surface 111a of the substrate body 111. That is, the bottom surface 10b of the element body 10 and the mounting surface 111a of the substrate body 111 face each other. For this reason, the microwave absorbing layers 31 and 32 of the electronic component 1 are present in a state of being exposed to the outside of the mounting structure 100. Therefore, it is possible to directly irradiate the microwave absorbing layers 31 and 32 with a microwave. That is, it is possible to irradiate the microwave absorbing layers 31 and 32 with a microwave without lowering heating efficiency.

Next, a separation method for an electronic component according to an exemplary embodiment of the present disclosure will be described.

First, the mounting structure 100 for an electronic component described above is prepared.

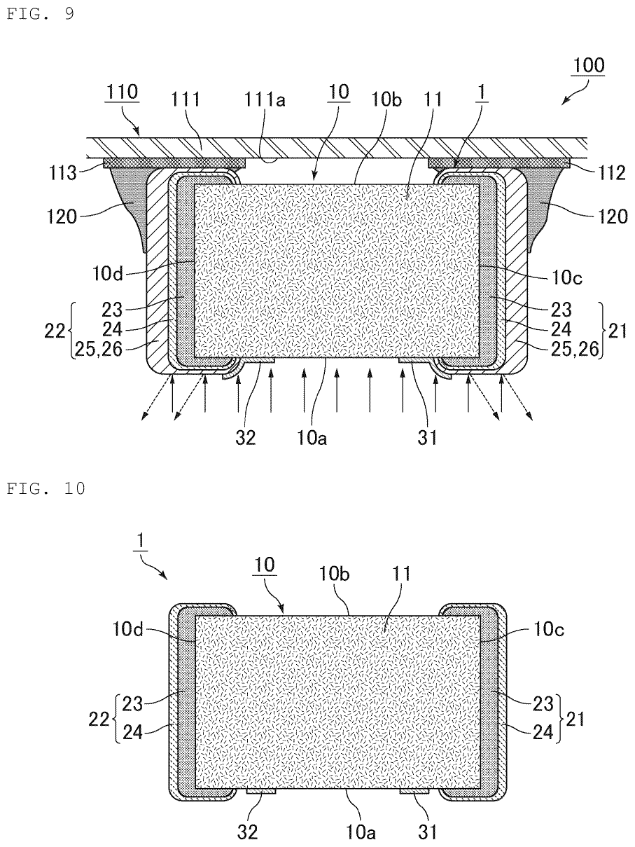

FIG. 9 is a sectional view schematically illustrating an example of an aspect in which an electronic component is irradiated with a microwave in the separation method for an electronic component according to the exemplary embodiment of the present disclosure. FIG. 10 is a sectional view schematically illustrating an example of an aspect in which an electronic component is separated in the separation method for an electronic component according to the exemplary embodiment of the present disclosure.

Next, as illustrated in FIG. 9, the mounting structure 100 is arranged in a microwave irradiation space such that the mounting surface 111a of the substrate body 111 faces downward.

Then, the microwave absorbing layers 31 and 32 of the electronic component 1 are irradiated with a microwave to be heated, and as illustrated in FIG. 10, the solder 120 is melted to separate the electronic component 1 from the mounting substrate 110. More specifically, the electronic component 1 is irradiated with a microwave (electric field is approximately 100%) such that the microwave is substantially uniform and maximum, and the microwave absorbing layers 31 and 32 are selectively and instantaneously heated. Then, as the microwave absorbing layers 31 and 32 are heated, heat is conducted from the microwave absorbing layers 31 and 32 to the solder 120, and the solder 120 to which heat is conducted is melted. As a result, the electronic component 1 is separated from the mounting structure 100 by free fall. In this way, the electronic component 1 can be easily separated from the mounting substrate 110.

When the Sn plating layer 26 is used as the outermost layer 25 of the external electrodes 21 and 22, the Sn plating layer 26 is also melted by heat conduction from the microwave absorbing layers 31 and 32, and the electronic component 1 is separated from the mounting substrate 110 in a state where the Sn plating layer 26 is removed as illustrated in FIG. 10. For this reason, the separated electronic component 1 can be reused, for example, by reforming the outermost layers 25 of the external electrodes 21 and 22.

Further, in a case where an Au plating layer is used as the outermost layer 25 of the external electrodes 21 and 22, the Au plating layer is not melted by heat conduction from the microwave absorbing layers 31 and 32, and the electronic component 1 is separated from the mounting substrate 110 in a state of having the Au plating layer. For this reason, the separated electronic component 1 can be reused as it is, for example.

Note that a microwave is generally an electromagnetic wave having a frequency range of 300 MHz to 3 THz, has an electric field component and a magnetic field component. The electric field component heats a dielectric and the magnetic field component heats a conductor and a magnetic body.

In the present exemplary embodiment, output of a microwave for irradiation is preferably 0.1 kW or more and 100 kW or less.

Further, a frequency of a microwave for irradiation is preferably 0.1 GHz or more and 100 GHz or less.

Further, irradiation time with a microwave is preferably 0.1 seconds or more and 100 seconds or less.

Further, as a microwave generator, a semiconductor oscillator can be used. The semiconductor oscillator is excellent in frequency controllability, and electromagnetic field distribution of microwaves generated from the semiconductor oscillator is fixed. For this reason, it is possible to emit a microwave such that the electronic component 1 is located in a space where an electric field is substantially uniform and maximized by position control of the electronic component 1.

Note that an irradiation method with a microwave is not particularly limited, and for example, the microwave absorbing layers 31 and 32 may be heated by moving a tip of a probe that emits a microwave to the vicinity of the electronic component 1.

Content below is disclosed in the present description.

<1>

An electronic component including:
an element body including a dielectric layer and having a top surface and a bottom surface facing each other in a height direction, a first side surface and a second side surface facing each other in a length direction orthogonal to the height direction, and a third side surface and a fourth side surface facing each other in a width direction orthogonal to the height direction and the length direction;
an external electrode provided on a surface of the element body; and
a microwave absorbing layer located on at least one of the top surface and four of the side surfaces and provided so as to be in contact with the external electrode,
in which a dielectric loss factor that is a product of a dielectric constant and a dielectric loss tangent of the microwave absorbing layer is ten or more.

<2>

An electronic component including:
an element body including a dielectric layer and having a top surface and a bottom surface facing each other in a height direction, a first side surface and a second side surface facing each other in a length direction orthogonal to the height direction, and a third side surface and a fourth side surface facing each other in a width direction orthogonal to the height direction and the length direction;
an external electrode provided on a surface of the element body; and
a microwave absorbing layer located on at least one of the top surface and four of the side surfaces and provided so as to be in contact with the external electrode,
in which a dielectric loss factor that is a product of a dielectric constant and a dielectric loss tangent of the microwave absorbing layer is two times or more a dielectric loss factor that is a product of a dielectric constant and a dielectric loss tangent of the dielectric layer.

<3>

The electronic component according to <1> or <2>, in which the microwave absorbing layer is provided so as to be in contact with the element body and the external electrode.

<4>

The electronic component according to <3>, in which the microwave absorbing layer is provided so as to be in contact with an outermost layer of the external electrode.

<5>

The electronic component according to <4>, in which the microwave absorbing layer has at least one of an end portion, a step portion, and a pointed end portion.

<6>

The electronic component according to any one of <1> to <5>, in which the electronic component is an electronic component for rebuilding or recycling.

<7>

A mounting structure for an electronic component, the mounting structure including:
the electronic component according to any one of <1> to <6>; and
a mounting substrate including a substrate body having a mounting surface and a land electrode formed on the mounting surface,
in which the external electrode of the electronic component is electrically connected to the land electrode via solder, and
the electronic component is mounted on the mounting substrate such that the top surface faces a side opposite to the mounting surface of the substrate body.

<8>

A separation method for an electronic component, the separation method including:
a step of preparing the mounting structure for an electronic component according to <7>; and
a step of irradiating the microwave absorbing layer of the electronic component with a microwave to heat the microwave absorbing layer, and melting the solder to separate the electronic component from the mounting substrate.

### DESCRIPTION OF REFERENCE SYMBOLS

1: Electronic component
10: Element body
10a: Top surface
10b: Bottom surface
10c: First side surface
10d: Second side surface
10e: Third side surface
10f: Fourth side surface
11: Dielectric layer
12: Dielectric ceramic layer
13, 14: Internal electrode layer
21, 22: External electrode
21a, 22a: End portion of external electrode
23: Resin electrode layer
24: Ni plating layer
25: Outermost layer
26: Sn plating layer
30A, 30B, 31, 32: Microwave absorbing layer
31a, 32a: End portion of microwave absorbing layer
31b, 32b: Step portion of microwave absorbing layer
31c, 32c: Pointed end portion of microwave absorbing layer
100: Mounting structure for electronic component
110: Mounting substrate
111: Substrate body
111a: Mounting surface
112, 113: Land electrode
120: Solder

1. An electronic component comprising:
an element body including a dielectric layer and having a top surface and a bottom surface facing each other in a height direction, a first side surface and a second side surface facing each other in a length direction orthogonal to the height direction, and a third side surface and a fourth side surface facing each other in a width direction orthogonal to the height direction and the length direction;
an external electrode provided on a surface of the element body; and
a microwave absorbing layer located on at least one of the top surface, the first side surface, the second side surface, the third side surface, or the fourth side surface and provided so as to be in contact with the external electrode.

2. The electronic component according to claim 1, wherein a dielectric loss factor that is a product of a dielectric constant and a dielectric loss tangent of the microwave absorbing layer is ten or more.

3. The electronic component according to claim 1,
wherein a dielectric loss factor that is a product of a dielectric constant and a dielectric loss tangent of the microwave absorbing layer is two times or more a dielectric loss factor that is a product of a dielectric constant and a dielectric loss tangent of the dielectric layer.

4. The electronic component according to claim 1, wherein the microwave absorbing layer is provided so as to be in contact with the element body and the external electrode.

5. The electronic component according to claim 4, wherein the microwave absorbing layer is provided so as to be in contact with an outermost layer of the external electrode.

6. The electronic component according to claim 5, wherein the microwave absorbing layer has at least one of an end portion, a step portion, or a pointed end portion.

7. The electronic component according to claim 1, wherein the electronic component is an electronic component for rebuilding or recycling.

8. The electric component according to claim 1, wherein the microwave absorbing layer is configured to contact an inner layer of the external electrode.

9. The electric component according to claim 1, wherein the microwave absorbing layer is configured to contact a plurality of electrodes.

10. The electric component according to claim 5, wherein the outermost layer of the external electrode includes Sn.

11. The electric component according to claim 5, wherein the outermost layer of the external electrode includes Au.

12. The electric component according to claim 1, wherein the microwave absorbing layer includes an oxide-based ceramic material.

13. The electric component according to claim 1, wherein a thickness of the microwave absorbing layer is 0.1 μm or more and 10 μm or less.

14. The electronic component according to claim 1, wherein
the electronic component is a part of a system,
the system further comprises a mounting substrate including a substrate body having a mounting surface and a land electrode formed on the mounting surface,
the external electrode of the electronic component is electrically connected to the land electrode via solder, and
the electronic component is mounted on the mounting substrate such that the top surface faces a side opposite to the mounting surface of the substrate body.

15. A electric component comprising,
an element body including a dielectric layer and having a top surface and a bottom surface facing each other in a height direction, a first side surface and a second side surface facing each other in a length direction orthogonal to the height direction, and a third side surface and a fourth side surface facing each other in a width direction orthogonal to the height direction and the length direction;
an external electrode provided on a surface of the element body; and
a microwave absorbing layer located on at least one of the top surface, the first side surface, the second side surface, the third side surface, or the fourth side surface and provided so as to be isolated from the external electrode.

16. The electric component according claim 15, wherein a dielectric loss factor that is a product of a dielectric constant and a dielectric loss tangent of the microwave absorbing layer is ten or more.

17. The electric component according claim 15, wherein a dielectric loss factor that is a product of a dielectric constant and a dielectric loss tangent of the microwave absorbing layer is two times or more a dielectric loss factor that is a product of a dielectric constant and a dielectric loss tangent of the dielectric layer.

18. A separation method for an electronic component, the separation method comprising:
preparing the electronic component;
irradiating a microwave absorbing layer of the electronic component with a microwave to heat the microwave absorbing layer; and
melting solder to separate the electronic component from a mounting substrate.
